(19) United States
(12) Patent Application Publication
(10) Pub. No.: US 2026/0364780 A1
(43) Pub. Date: Nov. 19, 2026

(54) ROBOT MANIPULATION DEVICE AND ROBOT

(71) Applicant: FANUC CORPORATION, Yamanashi (JP)

(72) Inventor: Takashi IZUMI, Yamanashi (JP)

(73) Assignee: FANUC CORPORATION, Yamanashi (JP)

(21) Appl. No.: 19/121,858

(22) PCT Filed: Dec. 6, 2022
(86) PCT No.: PCT/JP2022/044953

§ 371 Date: Apr. 17, 2025

(51) Int. Cl. B25J 9/00; B25J 13/08

(52) U.S. Cl. CPC B25J 9/0081; B25J 13/085

(57) ABSTRACT

A robot manipulation device to be mounted on a robot that detects a force applied by an operator and can be operated by lead-through control, in which a position and a posture thereof are changed in accordance with the detected force. The robot manipulation device includes: a bracket for attaching a tool to a flange disposed at a leading end of the robot; and first and second handles secured to the bracket and gripped by the operator, where the first handle is disposed so as to extend along a direction intersecting a rotation axis, and the second handle is disposed so as to extend in a direction intersecting a plane which includes the rotation axis and is parallel to a direction in which the first handle extends.

### TECHNICAL FIELD

The present disclosure relates to a robot manipulation device and a robot.

### BACKGROUND

There is a known robot manipulation device with which an operator manipulates a robot by applying forces thereto in order to operate the robot by means of lead-through control (for example, see Japanese Unexamined Patent Application, Publication No. 2019-34412).

This robot manipulation device includes two handles that the operator respectively grips with his/her two hands, and the robot is operated by means of a resultant force of forces applied to the two handles.

A tool, such as a hand portion, is secured to a flange provided at a most leading end of the robot along a rotation axis of the flange, and the two handles extend to the two sides sandwiching a center plane (a plane extending through a center of two fingers of the hand portion in a direction orthogonal to an opening/closing direction of the fingers) of the tool. Accordingly, the operator standing in front of the tool can respectively grip the two handles with his/her two hands.

### SUMMARY

An aspect of the present disclosure is a robot manipulation device to be mounted on a robot that detects a force applied by an operator and can be operated by means of lead-through control in which a position and a posture thereof are changed in accordance with the detected force, the robot manipulation device including: a bracket for attaching a tool to a flange disposed at a leading end of the robot; and first and second handles secured to the bracket and gripped by the operator, wherein the first handle is disposed so as to extend along a direction intersecting a rotation axis of the flange, and the second handle is disposed so as to extend in a direction intersecting a plane which includes the rotation axis and is parallel to a direction in which the first handle extends.

### BRIEF DESCRIPTION OF DRAWINGS

FIG. 1 is a side view showing a robot according to an embodiment of the present disclosure, the robot having a laser processing head mounted thereon.

FIG. 2 is a front view showing the robot in FIG. 1.

FIG. 3 is a perspective view showing a robot manipulation device according to the embodiment of the present disclosure provided in the robot in FIG. 1.

FIG. 4 is an exploded perspective view for explaining an example of attaching handles to a bracket of the robot manipulation device in FIG. 3.

FIG. 5 is a perspective view showing a state in which the robot manipulation device in FIG. 3 is attached to a flange and the laser processing head.

FIG. 6 is a perspective view showing a state in which an operator is gripping grips of a second handle and a third handle of the robot manipulation device in FIG. 3 with his/her two hands.

FIG. 7 is a perspective view showing an example of a moving direction of the robot due to forces applied to the grips of the robot manipulation device in FIG. 6 by the two hands of the operator.

FIG. 8 is a perspective view showing another example of the moving direction of the robot due to forces applied to the grips of the robot manipulation device in FIG. 6 by the two hands of the operator.

FIG. 9 is a perspective view showing another example of the moving direction of the robot due to forces applied to the grips of the robot manipulation device in FIG. 6 by the two hands of the operator.

FIG. 10 is a front view showing an example of the moving direction of the robot due to forces applied to grip portions of the second handle and the third handle of the robot manipulation device in FIG. 6 by the two hands of the operator.

FIG. 11 is a perspective view showing another example of the moving direction of the robot due to forces applied to the grip portions of the second handle and the third handle of the robot manipulation device in FIG. 6 by the two hands of the operator.

FIG. 12 is a side view showing another example of the moving direction of the robot due to forces applied to the grip portions of the second handle and the third handle of the robot manipulation device in FIG. 6 by the two hands of the operator.

FIG. 13 is a side view showing another example of the moving direction of the robot due to forces applied to the grip portions of the second handle and the third handle of the robot manipulation device in FIG. 6 by the two hands of the operator.

FIG. 14 is a perspective view showing a state in which the operator is gripping the grips of a first handle and the second handle of the robot manipulation device in FIG. 3 with his/her two hands.

FIG. 15 is a side view showing an example of the moving direction of the robot due to forces applied to a grip portion of the first handle and the grip of the second handle of the robot manipulation device in FIG. 14 by the two hands of the operator.

FIG. 16 is a perspective view showing another example of the moving direction of the robot due to forces applied to the grip portion of the first handle and the grip of the second handle of the robot manipulation device in FIG. 14 by the two hands of the operator.

FIG. 17 is a perspective view showing a state in which the robot manipulation device in FIG. 3 is attached to the flange and a welding torch.

### DETAILED DESCRIPTION OF EMBODIMENTS

A robot manipulation device 1 and a robot 100 according to an embodiment of the present disclosure will be described below with reference to the drawings.

The robot 100 according to this embodiment has a built-in sensor that detects forces applied by an operator. The robot 100 can be operated by means of lead-through control that changes the position and the posture of the robot 100 in accordance with the magnitudes and the directions of the forces detected by the sensor.

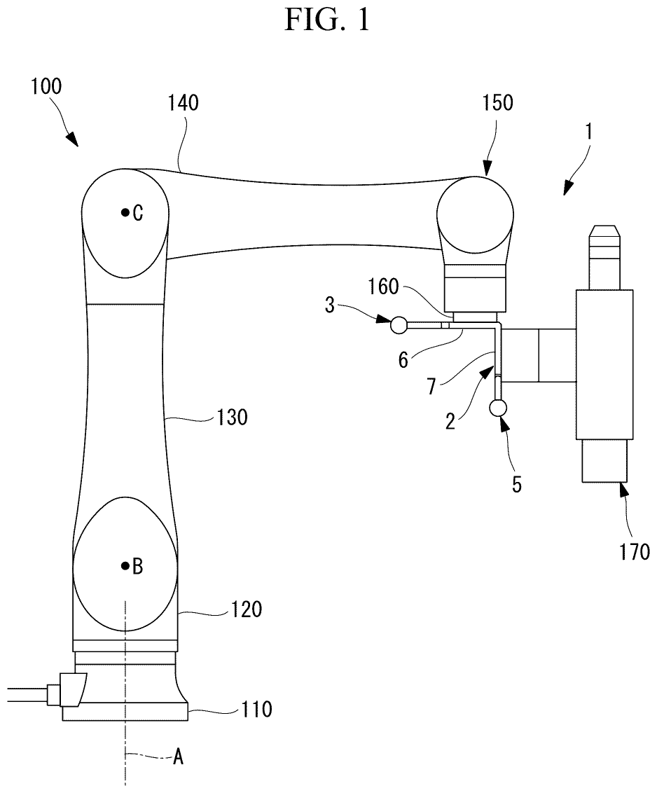

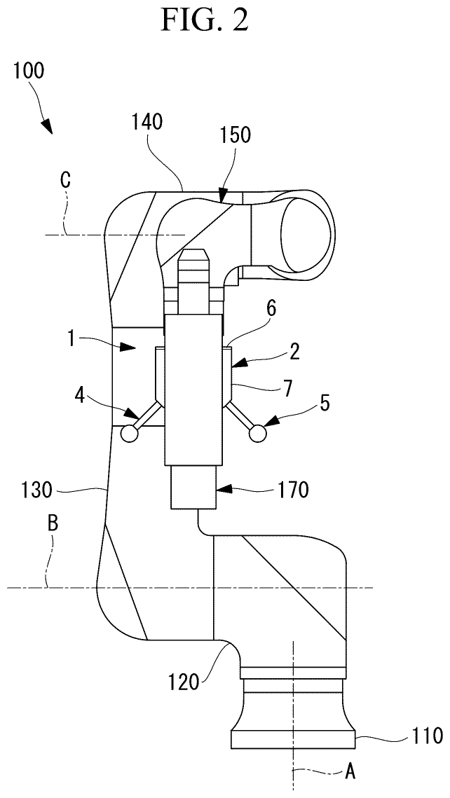

The robot 100 is, for example, as shown in FIGS. 1 and 2, a vertical six-axis articulated type robot. The robot 100 includes: a base 110 to be installed on an installation surface, such as a floor surface; and a rotary barrel 120 that is supported so as to be rotatable about a first axis A with respect to the base 110.

In addition, the robot 100 includes: a first arm 130 that is supported by the rotary barrel 120 so as to be rotatable about a second axis B; and a second arm 140 that is supported by the first arm 130 so as to be rotatable about a third axis C. In addition, the robot 100 includes a three-axis wrist unit 150 supported by a leading end of the second arm 140.

The wrist unit 150 includes a flange 160 that is rotatable about a rotation axis (sixth axis) X at a most leading end thereof. The robot 100 according to this embodiment includes the robot manipulation device 1 secured to the flange 160.

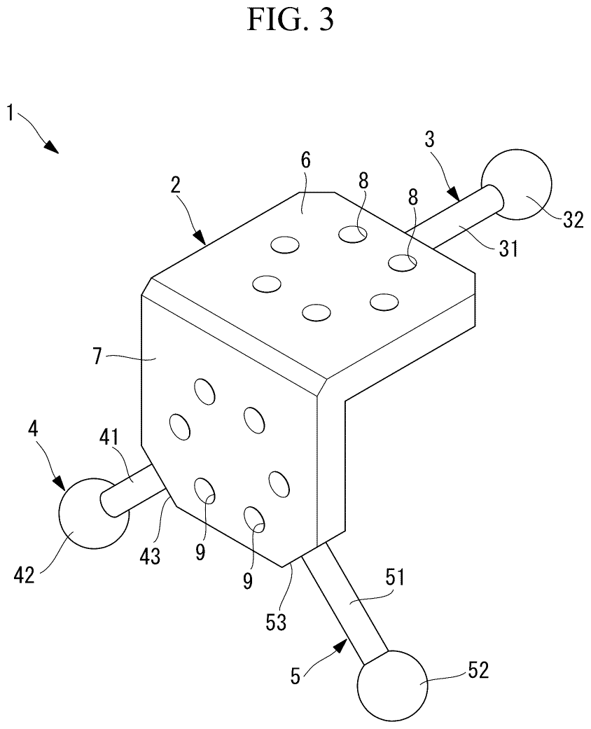

As shown in FIG. 3, the robot manipulation device 1 according to this embodiment includes: a bracket 2 secured to the flange 160; and three handles (first to third handles) 3, 4, 5 secured to the bracket 2.

The bracket 2 is a member for securing, for example, an elongated tool (hereinafter referred to as a laser processing head 170 in this embodiment), such as a laser processing head 170, to the flange 160. The bracket 2 includes: a flat plate-shaped first flat plate portion 6 to be secured to the flange 160; and a flat plate-shaped second flat plate portion 7 to which the laser processing head 170 is secured. Each of the first flat plate portion 6 and the second flat plate portion 7 is formed in a rectangular shape. The bracket 2 has an L-shape in which a side of the first flat plate portion 6 and a side of the second flat plate portion 7 are integrally joined together such that the two flat plate portions are disposed so as to form a 90° angle with respect to each other.

The first flat plate portion 6 includes a plurality of through-holes 8 for respectively allowing bolts to pass therethrough, the bolts being fastened into screw holes (not shown) provided in the flange 160. In addition, the second flat plate portion 7 includes a plurality of through-holes 9 for respectively allowing bolts to pass therethrough, the bolts being fastened into screw holes (not shown) provided in the laser processing head 170.

The bracket 2 can be secured to the flange 160 by fastening the bolts passing through the through-holes 8 of the first flat plate portion 6, an outer surface of which is in firm contact with a surface of the flange 160, to the screw holes of the flange 160. In addition, the bolts passing through the through-holes 9 of the second flat plate portion 7, an outer surface of which is in firm contact with a surface of the laser processing head 170, are fastened into the screw holes of the laser processing head 170. Accordingly, the bracket 2 can be secured to the laser processing head 170.

As shown in FIG. 3, the three handles 3, 4, 5 each include: a grip portion 31, 41, 51 to be gripped by the operator; and a spherical grip (protrusion) 32, 42, 52 provided at one end in the length direction of the grip portion 31, 41, 51. The grip portion 31, 41, 51 preferably has a rod-like shape having a circular shape in cross section; however, other arbitrary shapes may be employed. The thickness and the length of the grip portion 31, 41, 51 may be arbitrary; however, it is preferable that the grip portion have, for example, an external diameter dimension in which the thumb and the index finger overlap when the operator grips the grip portion with his/her left or right hand and a length dimension that is equivalent to or greater than the width dimension of a fist of the operator.

The grip 32, 42, 52 has an external diameter dimension that is greater than the external diameter dimension of the grip portion 31, 41, 51 and protrudes in a radial direction from an outer circumferential surface of the grip portion 31, 41, 51. By spherically forming the grip 32, 42, 52, it is possible to apply a force to the grip 32, 42, 52 in an arbitrary direction, regardless of the directions in which the grip portion 31, 41, 51 is disposed and oriented. In particular, by forming the grip 32, 42, 52 so as to have a greater size than the grip portion 31, 41, 51, it is also possible to easily apply, to the grip portion 31, 41, 51, a force for pulling the grip portion 31, 41, 51 in a longitudinal direction by gripping the grip 32, 42, 52 or hooking the fingers thereon.

As shown in FIG. 3, the first handle 3 is secured at a center of an end surface of the first flat plate portion 6 on the opposite side from the side thereof to which the second flat plate portion 7 is joined and is disposed such that the grip portion 31 extends in a direction orthogonal to the end surface.

The second handle 4 and the third handle 5 are secured to chamfered surfaces (inclined surfaces) 43, 53 provided at two ends of an end surface of the second flat plate portion 7 on the opposite side from the side thereof to which the first flat plate portion 6 is joined. The second handle 4 and the third handle 5 are disposed such that each of the grip portions 41, 51 extends in a direction orthogonal to each of the chamfered surfaces 43, 53. Each of the chamfered surfaces 43, 53 forms a 45° angle with respect to the end surface, and, in a state of being secured to the two chamfered surfaces 43, 53, the second handle 4 and the third handle 5 are disposed so as to form a 90° angle with respect to each other.

The chamfered surfaces 43, 53 may be formed at an arbitrary angle. In addition, the chamfered surfaces 43, 53 may not be provided.

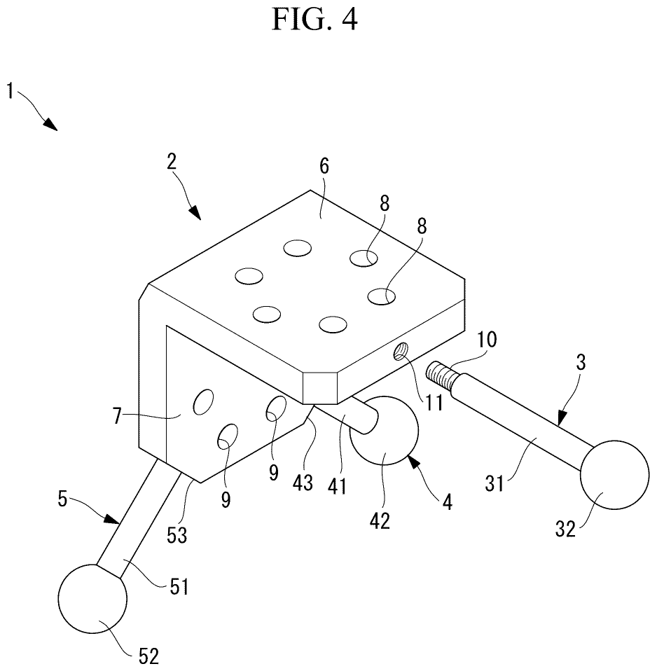

As shown in FIG. 4, each of the handles 3, 4, 5 has, for example, a male screw portion 10 in an end portion on the opposite side from each of the grips 32, 42, 52. Each of the handles 3, 4, 5 is secured to the bracket 2 in a detachable manner by fastening the male screw portion 10 into a screw hole 11 formed in each of the end surface of the first flat plate portion 6 and the chamfered surfaces 43, 53. In the case in which the chamfered surfaces 43, 53 are not provided, the screw holes 11 may be formed in the end surface of the second flat plate portion 7 in an inclined manner.

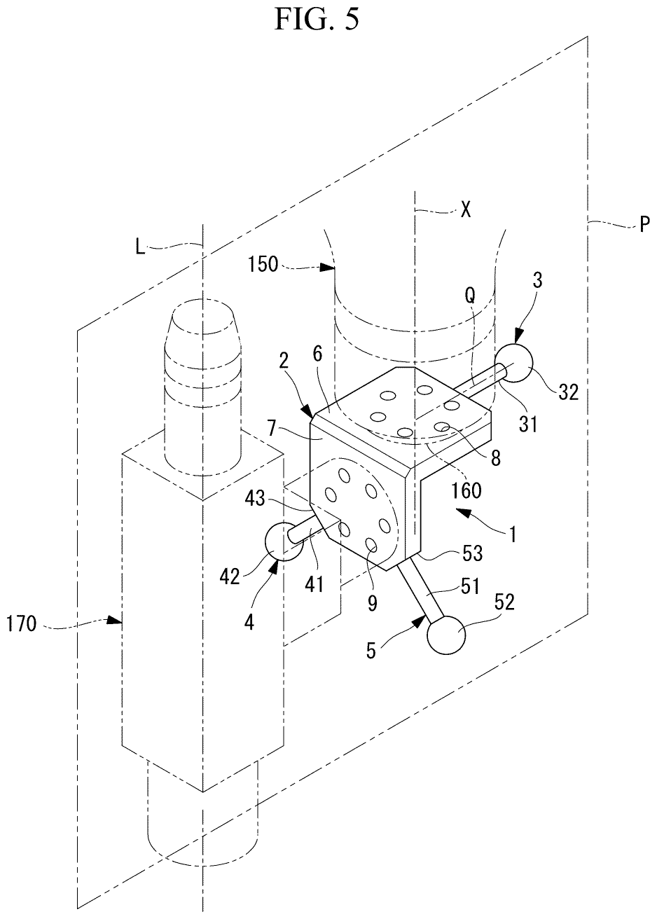

The laser processing head 170 is a device that radiates laser light guided thereto from a light source onto a workpiece from an emission end, and, in the example shown in FIG. 5, the laser processing head 170 is an elongated tool in which a longitudinal axis L passing through the center of the emission end facing downward is disposed in the vertical direction.

Because the laser processing head 170 has an elongated form, as described above, the laser processing head 170 cannot pass through the interior of the wrist unit 150 and is supported by the bracket 2 at an eccentric position with respect to the rotation axis X of the flange 160.

In this embodiment, the laser processing head 170 is secured to the bracket 2 in a state in which the longitudinal axis L thereof is disposed at a position that is offset substantially parallel to the rotation axis X of the flange 160. Here, “substantially parallel” includes not only a case in which the longitudinal axis L is disposed in an accurately parallel manner, but also a case in which there is a minute angle with respect to the rotation axis X, for example, a case in which there is an angle in the range of ±15°.

When the laser processing head 170 is secured to the second flat plate portion 7 of the bracket 2 secured to the flange 160 by means of the first flat plate portion 6, the rotation axis X and the longitudinal axis L of the laser processing head 170 are disposed in substantially the same plane (hereinafter referred to as the tool plane P). Here, “substantially the same plane” includes not only a case in which the two axes are accurately in the same plane, but also a case in which the two axes are approximately in the same plane, even though the rotation axis X and the longitudinal axis L of the laser processing head 170 form a minute angle therebetween.

As shown in FIG. 5, the first handle 3 secured to the first flat plate portion 6 of the bracket 2 is disposed along the tool plane (plane) P. Here, “the first handle 3 . . . is disposed along the tool plane P” also includes a case in which the first handle 3 is disposed along a plane that is substantially parallel to the tool plane P in addition to a case in which a longitudinal axis Q of the first handle 3 is accurately disposed in the tool plane P. In addition, as shown in FIG. 5, the second handle 4 and the third handle 5 secured to the second flat plate portion 7 are respectively disposed at a 45° angle with respect to the tool plane P. As a result of the second handle 4 and the third handle 5 being disposed at the same angle, it is possible to more accurately cancel out left-and right-direction components of forces that act on the second handle 4 and the third handle 5.

The operation of the thus-configured robot manipulation device 1 and robot 100 according to this embodiment will be described below.

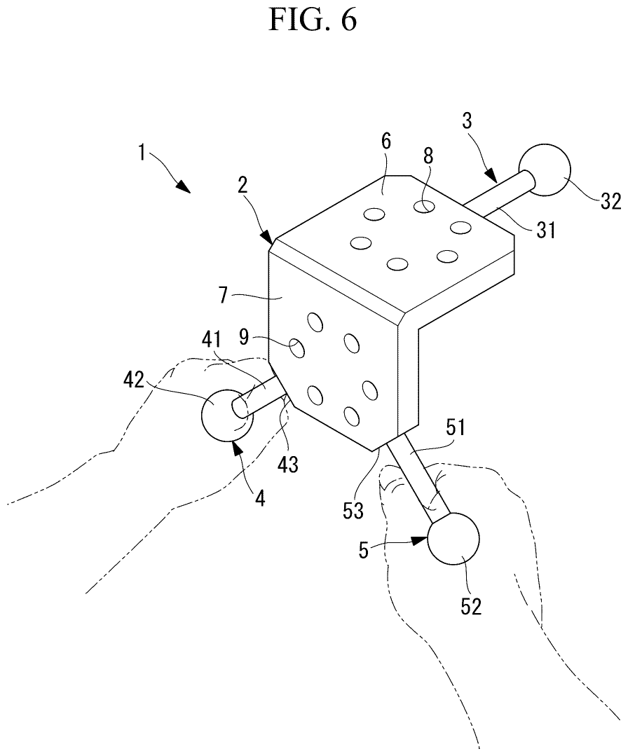

In order to perform teaching by employing the robot manipulation device 1 according to this embodiment while the robot 100 is controlled by means of lead-through control, an operator grips the second handle 4 with his/her left hand and grips the third handle 5 with his/her right hand, as shown in FIG. 6. Then, for example, the operator presses down a lead-through switch (not shown) provided in the vicinity of the third handle 5. By doing so, lead-through control is activated.

Accordingly, the sensor built into the robot 100 detects the forces applied to the second handle 4 and the third handle 5 by the operator and the robot 100 is moved to a position and posture in accordance with the detected forces. Then, at a desired position, as a result of, for example, the operator pressing down a teach button (not shown) provided in the vicinity of the second handle 4, the angles of the respective axes of the robot 100 at the time at which the button is pressed down are stored. By repeating these motions, an operating program of the robot 100 can be taught.

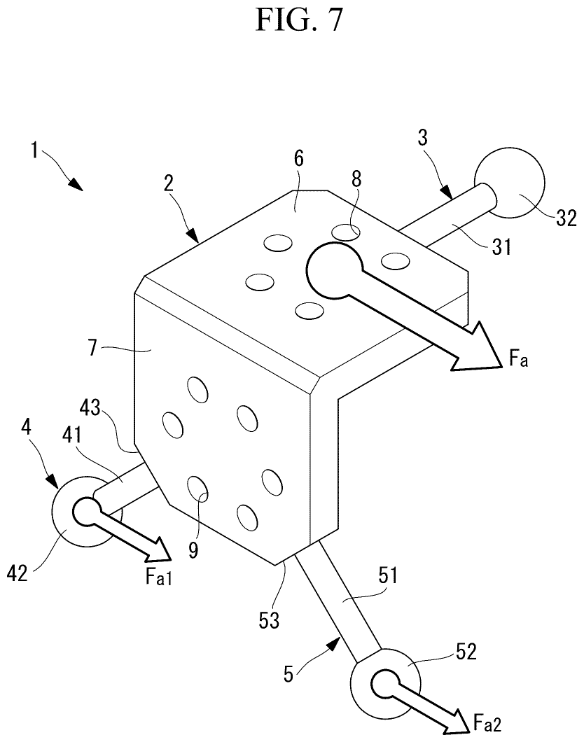

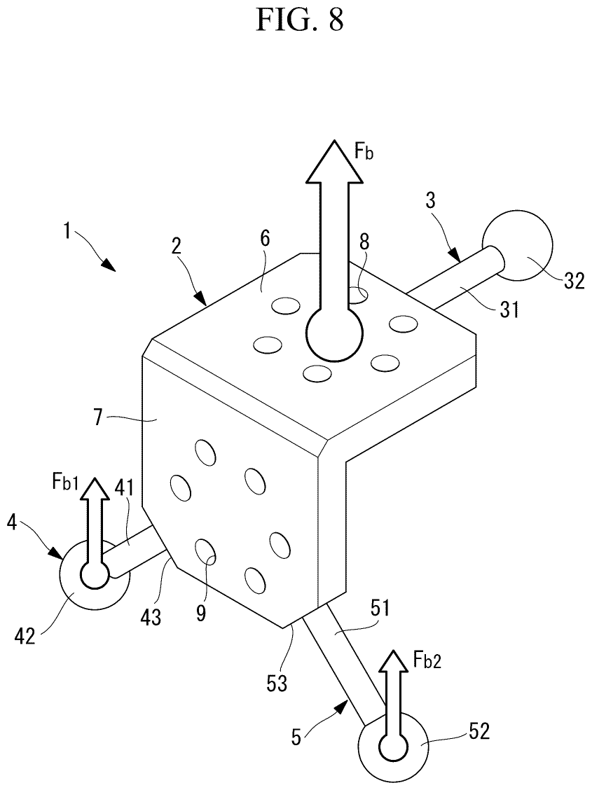

In this case, with this embodiment, by simultaneously applying forces of the same magnitude to the second handle 4 and the third handle 5 in the same direction, the laser processing head 170 can be translated in an arbitrary direction in which the forces are applied. For example, as shown in FIGS. 7 and 8, by applying forces Fai and Fₐ₂, F_{b1} and F_{b2} to the spherical grips 42, 52 of the second handle 4 and the third handle 5 in the same direction, the laser processing head 170 can be translated in a direction Fₐ, F_{b} in which the forces are applied.

In the figures, the thin arrows indicate the positions at which and the directions in which the operator applies forces, and the thick arrow indicates the moving direction of the laser processing head 170. FIGS. 7 and 8 show one direction 14 orthogonal to the tool plane P and one direction along the tool plane P; however, the laser processing head 170 can be translated in a similar manner in another direction orthogonal to the tool plane P and another direction along the tool plane P.

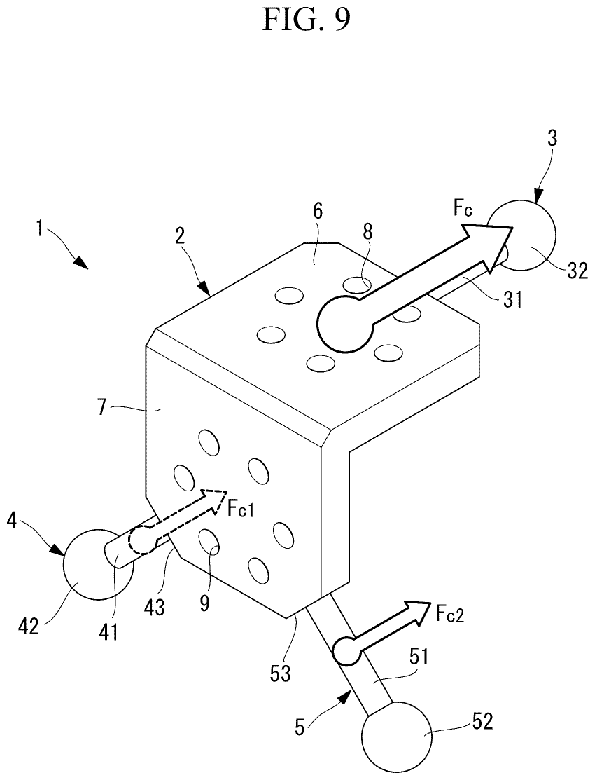

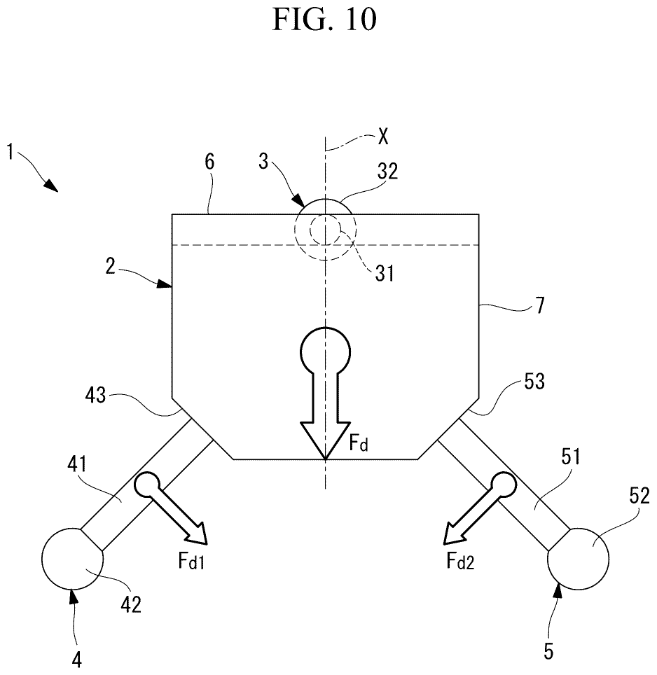

In addition, as shown in, for example, FIG. 9, so long as the direction is in a direction F_{c} orthogonal to the rotation axis X and along the tool plane P, the laser processing head 170 can be translated even if the operator applies forces F_{c1}, F_{c2} by gripping the grip portions 41, 51. In addition, as shown in FIG. 10, so long as the direction is in a direction F_{d} along the rotation axis X, the laser processing head 170 can be translated even if the operator applies forces F_{d1}, F_{d2} by gripping the grip portions 41, 51. In addition, when the laser processing head 170 is translated, the laser processing head 170 may be translated by applying forces by gripping not only the grip portions 41, 51 but also the grip portion 31 of the first handle 3. By doing so, rotation can be suppressed.

In this case, the left-and right-direction components of the forces acting on the respective handles 4, 5 from the left and right hands are naturally canceled out, making it easier to translate the laser processing head 170 straight along the rotation axis X. FIG. 10 shows an example case of translating the laser processing head 170 downward along the rotation axis X; however, the case of translating the laser processing head 170 upward is also similar.

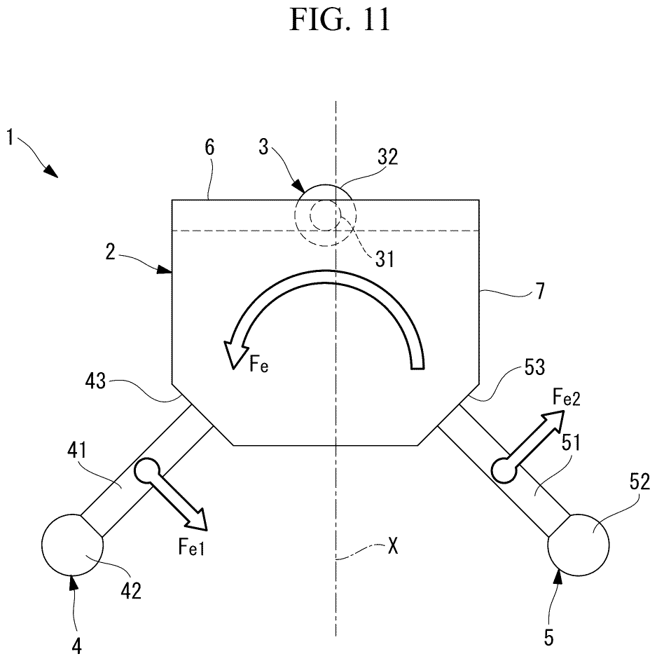

In addition, as shown in, for example, FIG. 11, by varying the directions of forces Fₑ₁, Fₑ₂ applied to the two handles 4, 5, the laser processing head 170 can be rotated in a direction Fₑ about an axis orthogonal to the rotation axis X of the flange 160. The case of rotating the laser processing head 170 about the rotation axis X of the flange 160 is also similar.

In addition, in this case, in a state in which the bracket 2 is attached to the flange 160 facing downward, the second handle 4 and the third handle 5 are disposed so as to extend downward in an inclined manner in directions in which the two handles separate from each other. Therefore, the operator can grip the second handle 4 with his/her left hand and the third handle 5 with his/her right hand in a natural state in which the two arms are relaxed and the two elbows are lowered.

Specifically, when the second handle 4 and the third handle 5 are gripped, the two hands can be placed so that the little fingers are on a diagonally lower side and the two handles can be naturally gripped without the operator tensing up the arms. Accordingly, the operability can be enhanced by increasing the movable ranges of the two arms of the operator when the laser processing head 170 is moved.

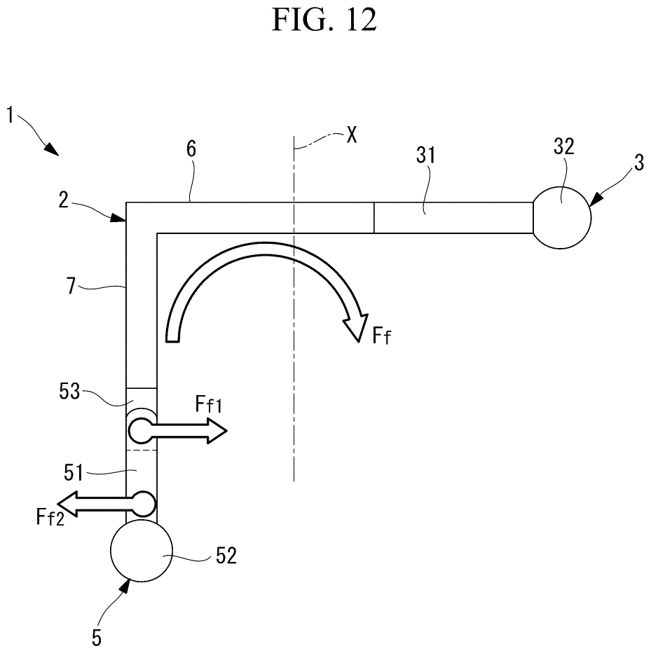

As shown in FIG. 12, in order to rotate the laser processing head 170 in a direction F_{f} about an axis orthogonal to the tool plane P by gripping the second handle 4 and the third handle 5, it is necessary to generate a moment for tilting the rotation axis X of the flange 160. The second handle 4 and the third handle 5 are disposed in the same plane orthogonal to the tool plane P, as shown in FIG. 5.

Accordingly, as shown in FIG. 12, with the two hands gripping the second handle 4 and the third handle 5, it is necessary to apply forces F_{f1}, F_{f2} to the grip portions 41, 51 of the respective handles 4, 5 at different positions in the length direction of the grip portions 41, 51 in different directions or with different magnitudes. In this case, it is necessary to adjust the forces F_{f1}, F_{f2} to be applied with the respective fingers and palms of the two hands, and thus, the operability decreases.

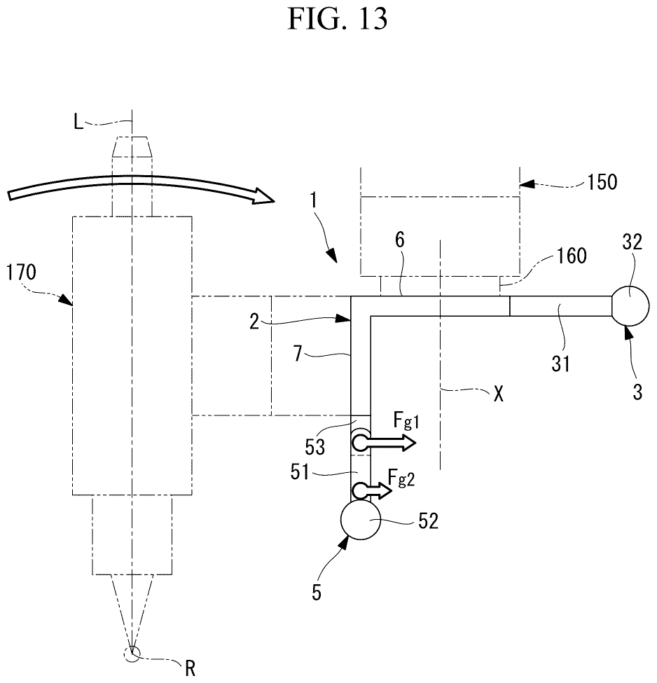

In particular, there are cases in which an irradiation position (work point) R for the laser light from the laser processing head 170 is far away from the flange 160. With forces F_{g1}, F_{g2} applied when the laser processing head 170 is rotated about such a work point R, as shown in FIG. 13, it is difficult to differentiate these forces from the forces to be applied when the laser processing head 170 is translated as shown in FIG. 9. Accordingly, it is difficult to precisely position the laser processing head 170.

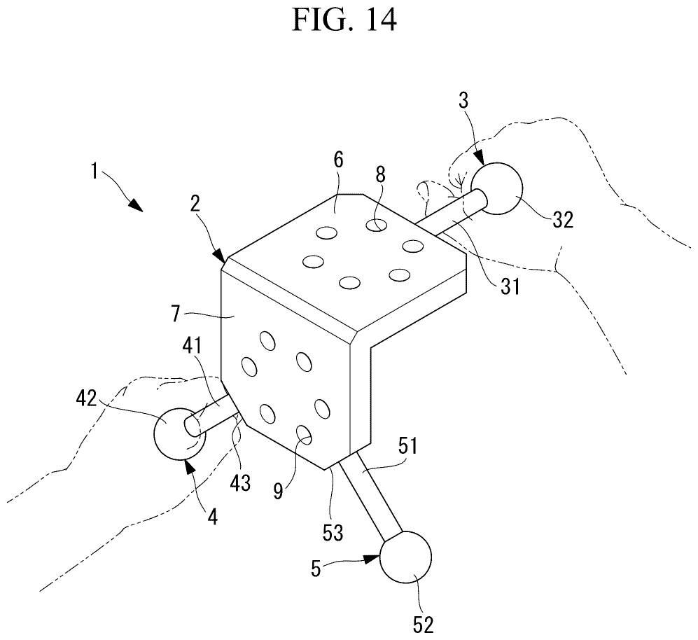

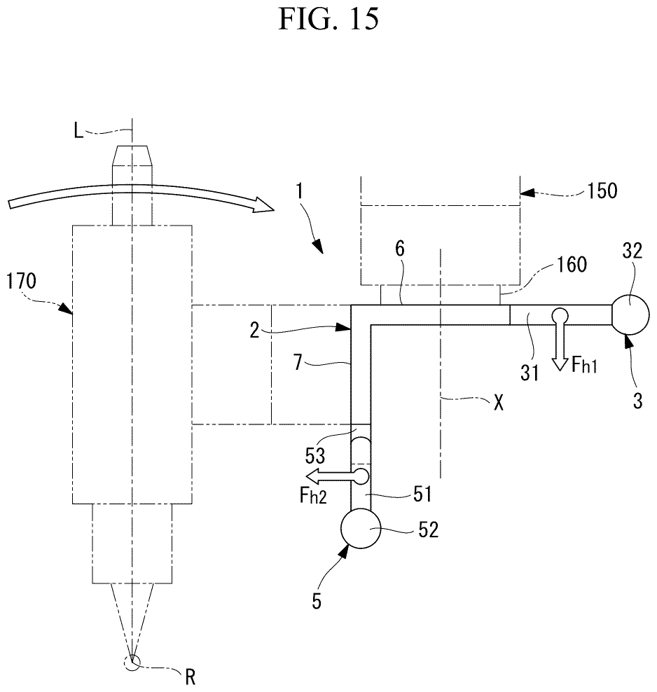

In such a case, as shown in FIGS. 14 and 15, the operator may switch to grip the first handle 3 by releasing his/her right hand from the third handle 5 or releasing his/her left hand from the second handle 4. The first handle 3 and the second handle 4 are not disposed in the same plane and the first handle 3 and the third handle 5 are also not disposed in the same plane. Accordingly, when the laser processing head 170 is rotated about an axis orthogonal to the tool plane P also, it is possible to vary the forces to be applied to the two handles 3, 4 or the two handles 3, 5.

In addition, the first handle 3 and the second handle 4 are disposed opposite from each other sandwiching the rotation axis X therebetween and the first handle 3 and the third handle 5 are also disposed opposite from each other sandwiching the rotation axis X therebetween. Accordingly, when the laser processing head 170 is rotated about a work point R that is far away from the flange 160 also, it is possible to apply forces Fₕ₁, Fₕ₂, which are clearly different from when the laser processing head 170 is translated, to the two handles 3, 4 or the two handles 3, 5, as shown in FIG. 15. As a result, it is possible to precisely position the laser processing head 170.

As has been described above, with this embodiment, the first handle 3 is disposed along the tool plane P orthogonal to the rotation axis X of the flange 160 and the second handle 4 is disposed in the direction intersecting the tool plane P at an angle. Accordingly, the first handle 3 and the second handle 4 are not disposed in the same plane; therefore, forces and moments in all directions can be generated by the forces Fₕ₁, Fₕ₂ applied to the first handle 3 and the second handle 4.

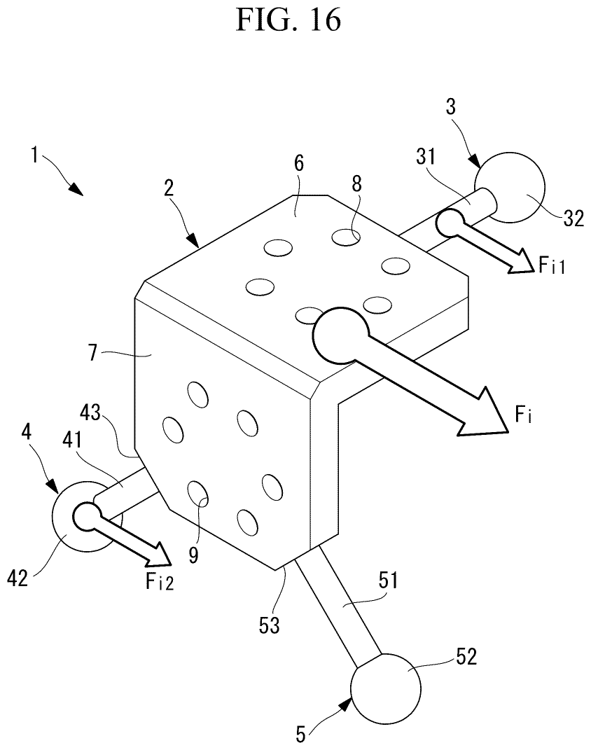

In addition, as shown in FIG. 16, it is also possible to achieve translation in a direction Fᵢ orthogonal to the tool plane P by applying forces Fᵢ₁, Fᵢ₂ to the grip portion 31 regarding the first handle 3 and the grip 42 regarding the second handle 4.

Note that, in this embodiment, the bracket 2 having an L-shaped structure in which the first flat plate portion 6 and the second flat plate portion 7 are joined has been described as an example. Alternatively, a bracket having an arbitrary shape, for example, a rectangular parallelepiped, a columnar block, or the like, may be employed.

In addition, in this embodiment, the bracket 2 having an L-shaped structure in which the first flat plate portion 6 and the second flat plate portion 7 are disposed at a 90°angle with respect to each other has been described as an example; however, it is not limited thereto. Specifically, the first flat plate portion 6 and the second flat plate portion 7 may be disposed at an angle other than 90°.

In addition, each of the second handle 4 and the third handle 5 is disposed at a 45° angle with respect to the tool plane P; however, the angle may be arbitrary. For example, the two handles 4, 5 may extend in directions orthogonal to the tool plane P.

In addition, a case in which the first handle 3 extends in the direction orthogonal to the rotation axis X of the flange 160 has been described as an example; however, alternatively, as with the second handle 4 and the third handle 5, the first handle 3 may be inclined downward in a direction away from the rotation axis X. Accordingly, when the first handle 3 is gripped also, it is possible to enhance the operability by increasing the movable ranges of the two arms of the operator when the laser processing head 170 is moved.

In addition, the second handle 4 and the third handle 5 are disposed along a plane that is orthogonal to the tool plane P and that is parallel to the rotation axis X of the flange 160; however, it is not limited thereto. For example, the two handles may be disposed along a plane that is orthogonal to the tool plane P and that is inclined with respect to the rotation axis X of the flange 160.

In addition, in this embodiment, a case in which the grips 32, 42, 52 are spherical has been described as an example; however, alternatively, grips having an arbitrary shape that protrude radially outward from outer surfaces of the grip portions 31, 41, 51 may be employed.

In addition, in this embodiment, a configuration in which the laser processing head 170 is secured to the bracket 2 in a state in which the longitudinal axis L is disposed at a position that is offset substantially parallel to the rotation axis X of the flange 160 has been described as an example. Alternatively, a configuration in which the laser processing head 170 is secured to the bracket 2 in a state in which the longitudinal axis L is disposed on the same line as the rotation axis X may be employed. Accordingly, the two handles 3, 4, the two handles 4, 5, or the two handles 3, 5 are disposed at positions sandwiching the rotation axis X therebetween; therefore, it is possible to more efficiently perform a rotational motion.

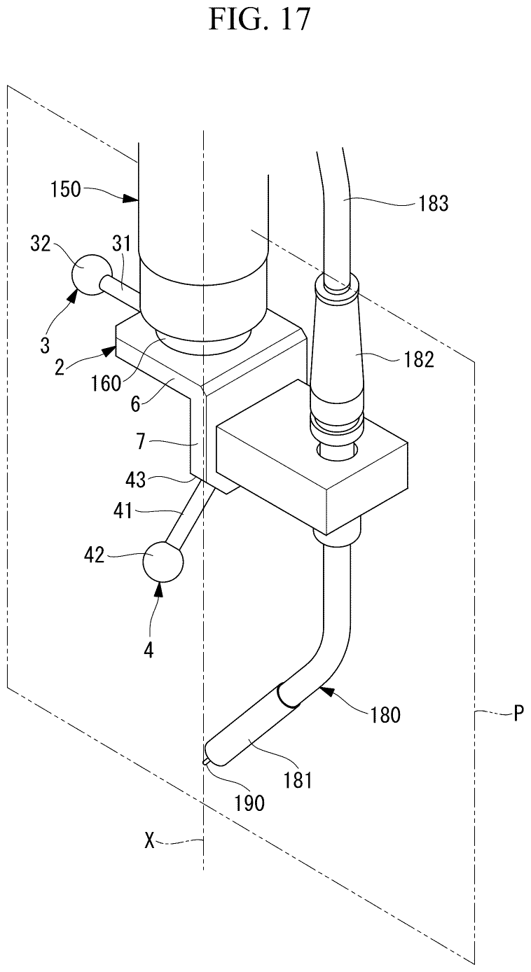

In addition, in this embodiment, a case in which the tool is the laser processing head 170 has been described as an example. Alternatively, as shown in FIG. 17, the robot manipulation device 1 may be applied to a case in which a welding torch 180 is employed as the tool.

The welding torch 180 includes: a tubular torch body 181 that is bent in one direction; a substantially columnar neck holder 182 that is connected to a basal end of the torch body 181; and a guide tube 183 that is connected to a basal end of the neck holder 182. The guide tube 183, the neck holder 182, and the torch body 181 include inner holes (not shown) through which a welding wire 190 passes. The welding torch 180 performs welding of a workpiece by making the welding wire 190 that has passed through the inner holes protrude from a leading end of the torch body 181 and generating arc between the workpiece and the welding wire 190.

The welding torch 180 also has an elongated form, as described above; therefore, the welding torch 180 cannot pass through the interior of the wrist unit 150 and is supported by the bracket 2 at an eccentric position with respect to the rotation axis X of the flange 160. Also, the torch body 181 is bent along the tool plane P, which includes the rotation axis X of the flange 160, from the position at which the torch body 181 is secured to the bracket 2, and is disposed so that the welding wire 190 protrudes at a position at which the welding wire 190 intersects the rotation axis X of the flange 160. The intersection between the rotation axis X of the flange 160 and the welding wire 190 generally serves as a work point for performing welding.

In addition, in this embodiment, the robot 100 having a built-in sensor has been described as an example. Alternatively, a sensor may be attached between the flange 160 of the robot 100 and the bracket 2.

In addition, in this embodiment, an example in which lead-through control is activated by pressing down the lead-through switch has been described. Alternatively, a configuration in which lead-through control is activated by means of a teach pendant of the robot 100 may be employed. In addition, a configuration in which a lead-through switch is not provided, and lead-through control is always active may be employed.

In addition, in this embodiment, an example in which the screw holes 11 are formed has been described, the screw holes 11 being formed in the end surface of the first flat plate portion 6 and the chamfered surfaces 43, 53. Alternatively, a plurality of screw holes 11 may be provided in the end surfaces of the first flat plate portion 6 and the second flat plate portion 7. Accordingly, it is possible to change the positions at which the respective handles 3, 4, 5 are attached.

In addition, in this embodiment, the handles 3, 4, 5 having different lengths from each other may be employed. For example, as a result of the second handle 4 and the third handle 5 having different lengths, the distance to a point of action changes; therefore, in the case in which the operator grips the grips 42, 52 to perform a rotational motion, the rotation can be performed more easily in a specific direction toward left or right. In addition, by switching the lengths of the two handles 4, 5, it is possible to switch the specific direction toward left or right into which rotation is easily performed.

As above, the individual embodiments of the present disclosure have been described in detail; however, the present disclosure is not limited to the individual embodiments described above. With the embodiments, various additions, replacements, alterations, partial deletions, etc. are possible within the range that does not depart from the scope of the invention or within the range that does not depart from the concept and spirit of the present invention derived from the matters stated in the claims and the equivalents thereof. For example, in the above-described embodiments, the order of the respective operations and the order of the respective procedures are indicated as examples, and it is not limited thereto.

Regarding the embodiments and modifications described above, the following notes will be further disclosed.

### Note 1

A robot manipulation device to be mounted on a robot that detects a force applied by an operator and can be operated by means of lead-through control in which a position and a posture thereof are changed in accordance with the detected force, the robot manipulation device including:
a bracket for attaching a tool to a flange disposed at a leading end of the robot; and
first and second handles secured to the bracket and gripped by the operator, wherein
the first handle is disposed so as to extend along a direction intersecting a rotation axis of the flange, and
the second handle is disposed so as to extend in a direction intersecting a plane which includes the rotation axis and is parallel to a direction in which the first handle extends.

### Note 2

The robot manipulation device according to Note 1, wherein the tool is attached to the bracket at an eccentric position with respect to the rotation axis.

### Note 3

The robot manipulation device according to Note 1 or 2, wherein the second handle is disposed on an opposite side from the first handle, sandwiching the rotation axis therebetween.

### Note 4

The robot manipulation device according to any one of Notes 1 to 3, wherein:
the bracket includes a first flat plate portion secured to the flange and a second flat plate portion that extends in a direction orthogonal to the first flat plate portion from one end edge of the first flat plate portion and to which the tool is attached;
the first handle is secured to an end surface of the first flat plate portion on an opposite side from the second flat plate portion; and
the second handle is secured to an end surface of the second flat plate portion.

### Note 5

The robot manipulation device according to Note 4, wherein the second handle is secured to an inclined surface provided in an end surface of the second flat plate portion on an opposite side from the first flat plate portion.

### Note 6

The robot manipulation device according to any one of Notes 1 to 5, wherein at least one of the first handle or the second handle includes a rod-like grip portion that the operator grips with his/her hand and a protrusion that is provided at a leading end of the grip portion and that protrudes from a surface of the grip portion.

### Note 7

The robot manipulation device according to any one of Notes 1 to 6, wherein the first handle is disposed so as to extend downward in an inclined manner in a direction away from the rotation axis in a state in which the bracket is attached to the flange disposed facing downward.

### Note 8

The robot manipulation device according to any one of Notes 1 to 7, further including a third handle that is secured to the bracket and that the operator grips with his/her hand, wherein
the third handle is disposed so as to extend in a direction intersecting the plane on an opposite side from the second handle, sandwiching the plane therebetween.

### Note 9

The robot manipulation device according to Note 8, wherein the second handle and the third handle are disposed so that the second handle and the third handle extend downward in an inclined manner in directions in which the second handle and the third handle separate from each other, in a state in which the bracket is attached to the flange disposed facing downward.

### Note 10

The robot manipulation device according to Note 4 or 5, further including a third handle that is secured to the bracket and that the operator grips with his/her hand, wherein the third handle is secured to another chamfered surface provided in an end surface of the second flat plate portion on an opposite side from the first flat plate portion.

### Note 11

The robot manipulation device according to any one of Notes 8 to 10, wherein the third handle includes a rod-like grip portion that the operator grips with his/her hand and a protrusion that protrudes, at a leading end of the grip portion in an axial direction, farther than the grip portion in a direction intersecting the axial direction.

### Note 12

The robot manipulation device according to Note 6 or 11, wherein the protrusion is spherical.

### Note 13

A robot including a robot manipulation device according to any one of Notes 1 to 12.

1. A robot manipulation device to be mounted on a robot that detects a force applied by an operator and can be operated by lead-through control in which a position and a posture thereof are changed in accordance with the detected force, the robot manipulation device comprising:
a bracket for attaching a tool to a flange disposed at a leading end of the robot; and
first and second handles secured to the bracket and gripped by the operator, wherein
the first handle is disposed so as to extend along a direction intersecting a rotation axis of the flange, and
the second handle is disposed so as to extend in a direction intersecting a plane which includes the rotation axis and is parallel to a direction in which the first handle extends.

2. The robot manipulation device according to claim 1, wherein the tool is attached to the bracket at an eccentric position with respect to the rotation axis.

3. The robot manipulation device according to Claim 1, wherein the second handle is disposed on an opposite side from the first handle, sandwiching the rotation axis therebetween.

4. The robot manipulation device according to Claim 1, wherein:
the bracket includes a first flat plate portion secured to the flange and a second flat plate portion that extends in a direction orthogonal to the first flat plate portion from one end edge of the first flat plate portion and to which the tool is attached;
the first handle is secured to an end surface of the first flat plate portion on an opposite side from the second flat plate portion; and
the second handle is secured to an end surface of the second flat plate portion.

5. The robot manipulation device according to claim 4, wherein the second handle is secured to an inclined surface provided in an end surface of the second flat plate portion on an opposite side from the first flat plate portion.

6. The robot manipulation device according to Claim 1, wherein at least one of the first handle or the second handle includes a rod-like grip portion that the operator grips with his/her hand and a protrusion that is provided at a leading end of the grip portion and that protrudes from a surface of the grip portion.

7. The robot manipulation device according to Claim 1, wherein the first handle is disposed so as to extend downward in an inclined manner in a direction away from the rotation axis in a state in which the bracket is attached to the flange disposed facing downward.

8. The robot manipulation device according to Claim 1, further comprising a third handle that is secured to the bracket and that the operator grips with his/her hand, wherein
the third handle is disposed so as to extend in a direction intersecting the plane on an opposite side from the second handle, sandwiching the plane therebetween.

9. The robot manipulation device according to claim 8, wherein the second handle and the third handle are disposed so that the second handle and the third handle extend downward in an inclined manner in directions in which the second handle and the third handle separate from each other, in a state in which the bracket is attached to the flange disposed facing downward.

10. The robot manipulation device according to Claim 4, further comprising a third handle that is secured to the bracket and that the operator grips with his/her hand, wherein
the third handle is secured to another chamfered surface provided in an end surface of the second flat plate portion on an opposite side from the first flat plate portion.

11. The robot manipulation device according to Claim 8, wherein the third handle includes a rod-like grip portion that the operator grips with his/her hand and a protrusion that protrudes, at a leading end of the grip portion in an axial direction, farther than the grip portion in a direction intersecting the axial direction.

12. The robot manipulation device according to Claim 6, wherein the protrusion is spherical.

13. A robot comprising the robot manipulation device according to Claim 1.
